(19) United States
(12) Patent Application Publication
(10) Pub. No.: US 2010/0270930 A1
(43) Pub. Date: Oct. 28, 2010

(54) APPARATUS AND METHODS OF OPERATION OF PASSIVE LED LIGHTING EQUIPMENT

(75) Inventor: Ron Shu Yuen HUI, New Territories (HK)

Correspondence Address: HESLIN ROTHENBERG FARLEY & MESITI PC, 5 COLUMBIA CIRCLE, ALBANY, NY, 12203, US

(73) Assignee: CITY UNIVERSITY OF HONG KONG, Kowloon (HK)

(21) Appl. No.: 12/474,001

(22) Filed: May 28, 2009

Related U.S. Application Data
(63) Continuation-in-part of application No. 12/429,792, filed on Apr. 24, 2009.

(51) Int. Cl. H05B 37/02; H01J 7/24

(52) U.S. Cl. 315/112; 315/291

(57) ABSTRACT

This invention is concerned with the control and design of a LED lighting system that does not need electrolytic capacitors in the entire system and can generate light output with reduced luminous flux fluctuation. The proposal is particularly suitable, but not restricted to, off-line applications in which the lighting system is powered by the ac mains. By eliminating electrolytic capacitors which have a limited lifetime of typically 15000 hours, the proposed system can be developed with passive and robust electrical components such as inductor and diode circuits, and it features long lifetime, low maintenance cost, robustness against extreme temperature variations and good power factor. No extra electronic control board is needed for the proposed passive circuits, which can become dimmable systems if the ac input voltage can be adjusted by external means. Optionally, the power sensitivity of the load against AC voltage fluctuation may be controlled.

### CROSS-REFERENCE TO RELATED APPLICATIONS

This application is a continuation-in-part of U.S. patent application Ser. No. 12/429,792, filed Apr. 24, 2009, which is hereby incorporated herein by reference in its entirety.

### FIELD OF THE INVENTION

The present invention relates to apparatus and methods for the operation of passive light emitting diode (LED) lighting equipment, and in particular to such apparatus and methods as may avoid the need to use electrolytic capacitors.

### BACKGROUND OF THE INVENTION

LED technology has been promoted as a promising lighting technology to replace energy-inefficient incandescent lamps and mercury-based linear and compact fluorescent lamps. It is often claimed by LED manufacturers that the LED devices have a long lifetime that could be higher than 5 years. However, the electrolytic capacitors used in the power circuit and the electronic controls for LED systems have a limited lifetime, typically 15000 hours (or 1.7 years) at an operating temperature of 105° C. The lifetime of an electrolytic capacitor is highly sensitive to the operating temperature. The lifetime is doubled if the operating temperature is decreased by 10° C. and halved if increased by 10° C. Therefore, the short lifetime of electronic control circuits (sometimes known as ballasts) for LEDs remains one major bottleneck in the utilization of LED technology.

In general, electrolytic capacitors are used in power inverter circuits and electronic control circuits for lighting systems because they provide the necessary large capacitance of the order of hundreds and even thousands of micro-Farads, while other more long-lasting capacitors such as ceramic, polypropylene and metalized plastic film capacitors have relatively less capacitance of several tens of micro-Farads or less. The large capacitance of electrolytic capacitors is usually needed to provide a stable dc link voltage for the ballast circuit to provide stable power (with reduced power variation) for the load; a stable dc power supply in the electronic control for the power inverter circuit.

FIG. 1 shows the schematic of a typical off-line lighting system. An off-line system here means a system that can be powered by the ac mains. The power conversion circuit can adopt a two-stage approach in which an AC-DC power stage with power factor correction is used as the first power stage, which is followed by a second dc-dc power conversion stage for controlling the current for LED load. An alternative to the two-stage approach is to employ a single-stage approach which combines the two power stages into one and such a technique has been reported in many off-line power supply designs. In both approaches, electrolytic capacitors are used to provide the energy storage and buffer so that the difference between the input power and the output power consumed by the load can be stored or delivered by the capacitors.

Regardless of whether a single-stage or a two-stage approach is used, a large capacitance (requiring the use of electrolytic capacitors) is needed as energy-storage to cater for the difference between the input power from the ac mains and the almost constant power of the LED load. The input power of an off-line lighting system is typically a periodically pulsating function as shown in FIG. 1. For example, if power factor is close to one, the input voltage and current are in phase and thus the input power follows a pulsating waveform (similar to a rectified sinusoidal waveform). If the lighting load is of constant power, then the capacitors are needed to absorb or deliver the difference in power between the ac mains and the lighting load as shown in FIG. 1.

An electronic ballast circuit without the use of electrolytic capacitors has been proposed. But the requirement for active power switches in such proposal means that an electronic control board that provides the switching signals for the active power switches is needed and this electronic control board needs a power supply that requires the use of electrolytic capacitors. In general, electrolytic capacitors are needed in a dc power supply for providing the hold-up time (i.e., to keep the dc voltage for a short period of time when the input power source fails.) Power electronic circuits that use active switches usually need a dc power supply for the gate drive circuits that provide switching signals for the active electronic switches. Therefore, it would be useful if a passive electronic ballast circuit can be developed for providing a stable current source for the LED load. A passive ballast circuit without active switches, electronic control board and electrolytic capacitors would be a highly robust and reliable solution that enhances the lifetime of the entire LED system. The remaining challenge is to determine how to provide a stable current source for the LED load based on a totally passive circuit.

### SUMMARY OF THE INVENTION

According to the present invention there is provided an LED lighting system comprising: (a) a rectification circuit for rectifying an AC input power and generating a rectified DC power, (b) a first circuit electrically coupled to the rectification circuit for reducing the voltage ripple of said rectified DC power, (c) a second circuit electrically coupled to the first circuit for generating a current source from the voltage ripple reduced rectified DC power, and (d) at least one LED electrically coupled to the second circuit and receiving said current source as an input.

Preferably the first circuit is a valley-fill circuit located between the rectification circuit and the second circuit. The valley-fill circuit may include a voltage-doubler.

Preferably the second circuit comprises an inductor. The second circuit may further function as a current ripple reduction circuit. Such a current ripple reduction circuit may comprise a coupled inductor with a capacitor.

Preferably means are also provided for reducing the sensitivity of the LED power to fluctuations in the AC input supply. This may be achieved, for example, by placing an inductor in series between the AC input supply and the diode rectification circuit. A capacitor may also be provided in parallel between this input inductor and the diode rectification circuit.

Such use of an input inductor may also be useful independently of providing reduction of voltage/current ripple and therefore according to another aspect of the invention there is also provided an LED lighting system comprising: an AC input power source, a rectification circuit for rectifying an AC input power and generating a rectified DC power, and an inductor provided in series between the AC input power source and the rectification circuit. Again, a capacitor may be provided in parallel between the inductor and the diode rectification circuit.

In preferred embodiments of the invention the power supplied to the at least one LED is permitted to vary, and at least one operating and/or design parameter of the at least one LED is chosen such that a variation in luminous flux resulting from the varying power is not observable to the human eye.

Viewed from another broad aspect the present invention provides a method of operating a LED lighting system comprising: (a) rectifying an AC input voltage to generate a rectified DC power, (b) reducing a voltage ripple of the rectified DC power, (c) generating a current source from the voltage ripple reduced rectified DC power, and (d) providing the current source as an input to at least one LED, wherein the power supplied to the at least one LED is permitted to vary, and wherein at least one operating and/or design parameter of the at least one LED is chosen such that a variation in luminous flux resulting from the varying power is not observable to the human eye.

Preferably a thermal characteristic of the at least one LED may be chosen such that the variation in luminous flux resulting from the varying power is not observable to the human eye. Such a thermal characteristic may comprise a design of a heatsink for the at least one LED and/or the provision of forced cooling or natural cooling.

Preferably a valley-fill circuit is used to reduce the voltage ripple of the rectified DC power. The valley-fill circuit may comprise a voltage-doubler.

In preferred embodiments of the invention the method further comprises reducing the current ripple of the current source. A coupled inductor with a capacitor may be used to reduce the current ripple.

Preferably the sensitivity of the LED power to fluctuations in the AC input supply voltage is also controlled.

### BRIEF DESCRIPTION OF THE DRAWINGS

Some embodiments of the invention will now be described by way of example and with reference to the accompanying drawings, in which:

FIG. 1 shows a schematic and power profiles of a typical off-line LED lighting system according to the prior art;

FIG. 2 shows a schematic and “modified” power profiles of an off-line LED lighting system according to an embodiment of the invention;

FIGS. 3(a)-(c) show the variation of LED power and luminous flux in an embodiment of the present invention;

FIGS. 4(a), (b) and (c) show (a) a schematic diagram of a passive off-line circuit design for an LED system using an inductor for current ripple reduction, and (b) and (c) using a coupled inductor for current ripple reduction;

FIG. 5 shows a schematic of an example of one possible hardware implementation of the proposed passive circuit for an off-line LED system using a standard valley-fill circuit;

FIG. 6 shows a model used for simulation of the circuit in FIG. 5;

FIG. 7 shows an example of a proposed passive circuit with a standard valley-fill circuit for multiple loads;

FIG. 8 shows an example of a proposed passive circuit using a valley-fill circuit with a voltage doubler for multiple loads;

FIG. 9 shows an LED system according to an embodiment of the invention under a simulation evaluation (L=1 H);

FIGS. 10(a) and (b) show (a) simulated input voltage and current of the system of FIG. 9, and (b) simulated input power of the system of FIG. 9;

FIGS. 11(a)-(d) show (a) simulated voltage and current of the LED module for the circuit of FIG. 9, (b) simulated total power for the LED module and for individual LEDs in the module for the system in FIG. 9, (c) and (d) two examples of the relationship between a variation of LED power and luminous flux fluctuation for a LED system using 3 W LED devices;

FIG. 12 shows an LED system according to an embodiment of the invention under a simulation evaluation (L=2 H);

FIGS. 13(a)-(d) show (a) simulated input voltage and current of the system of FIG. 12, (b) simulated input power of the system of FIG. 12, (c) and (d) two examples of the relationship between a variation of LED power and luminous flux fluctuation for a LED system using 3 W LED devices;

FIG. 14 shows an embodiment of a LED system with “coupled inductor” of L=2 H under simulation evaluation (L=2 H);

FIGS. 15(a)-(d) show (a) simulated input voltage and current of the system of FIG. 14, (b) simulated input power of the system of FIG. 14, (c) and (d) two examples of the relationship between a variation of LED power and luminous flux fluctuation for a LED system using 3 W LED devices;

FIG. 16 shows a diode-clamp that may be added to each LED string in embodiments of the invention;

FIGS. 17(a) and (b) illustrate the use of the valley-fill circuit in reducing the voltage ripple;

FIG. 18 shows a circuit according to a further embodiment of the invention;

FIGS. 19(a)-(d) show idealized waveforms in the circuit of FIG. 18;

FIG. 20 shows a simplified equivalent circuit of FIG. 18;

FIG. 21 shows a vectorial relationship in the equivalent circuit of FIG. 20;

FIG. 22 shows a circuit according to a still further embodiment of the invention; and

FIG. 23 shows a circuit according to a still further embodiment of the invention.

### DETAILED DESCRIPTION OF PREFERRED EMBODIMENTS

One important aspect of this invention at least in its preferred forms is to provide a way to reduce the size of the capacitors that is needed so that capacitors other than the electrolytic type can be used. With electrolytic capacitors eliminated in the lighting system, the whole system can be more reliable and last longer.

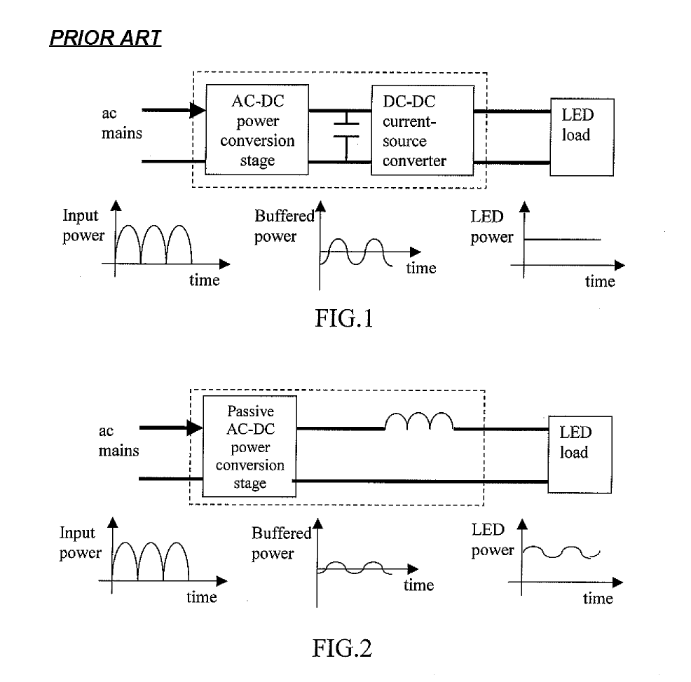

FIG. 2 is a modified version of FIG. 1 and is used to illustrate this aspect of the invention. If the LED load power is allowed to fluctuate to some extent, the amount of energy buffer required in the energy-storage element of the system becomes less and therefore the size of the capacitance can be reduced to a level that other non-electrolytic capacitors can be used to replace the electrolytic capacitor. Furthermore as the circuit contains only passive components rather than active components complicated control circuitry (which may also require electrolytic capacitors) can be avoided.

In addition to the elimination of electrolytic capacitors, the design is also concerned with the input power factor because there is an international standard IEC-61000 governing the input power factor. Passive power correction circuits such as valley-fill circuits and their variants [K. Kit Sum, “Improved Valley-Fill Passive Current Shaper,” Power System World 1997, pages 1-8; Lam, J.; Praveen, K.; “A New Passive Valley Fill Dimming Electronic Ballast with Extended Line Current Conduction Angle,” INTELEC '06. 28th Annual International Telecommunications Energy Conference, 2006. 10-14 Sep. 2006, pages 1-7], incorporated herein by reference, can be used in the passive ballast circuit in embodiments of this invention.

Valley-fill circuits allow the input current to be smoothed so that the current distortion factor and thus the input power factor can be improved. The choice of the capacitors used in the valley-fill circuit can be made so that non-electrolytic capacitors can be used. Unlike previous applications, the valley-fill circuit is used in embodiments of this invention to reduce the output voltage ripple which in turn will reduce the current ripple in the later power stage. This aspect of the valley-fill circuit application has not been reported previously because in the prior art valley-fill circuits were primarily used for voltage source applications and were used as a means for input power factor correction with their outputs are nominally connected directly to another power converter or a load. For example, in the National Semiconductor Note: LM3445 Triac Dimmable Offline LED Driver March 2009, incorporated herein by reference, the two capacitors C7 and C9 in the valley-fill circuit are electrolytic capacitors and the valley-fill circuit provides a “voltage source” to a buck converter which in turn controls the power of the LED load. Such example of valley-fill circuit application highlights the traditional use of “electrolytic capacitor” in absorbing large power variation and the voltage source nature of prior art.

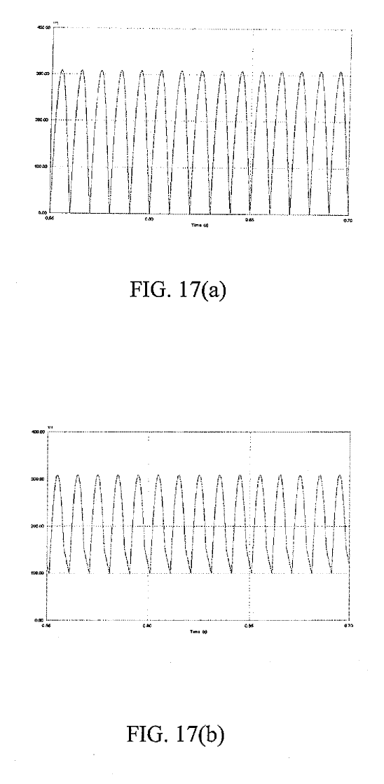

In contrast in embodiments of the present invention valley-fill circuits are used to reduce the input voltage ripple. As shown in FIG. 17(a), the output voltage of the diode rectifier has high voltage ripple. However, the output voltage of the valley-fill circuit is significantly reduced as shown in FIG. 17(b). In embodiments of this invention, the valley-fill circuit is not connected directly to the load or another power converter as in prior art, but is connected directly to an inductor or a coupled-inductor based current ripple cancellation circuit for providing a smooth current to the LED load.

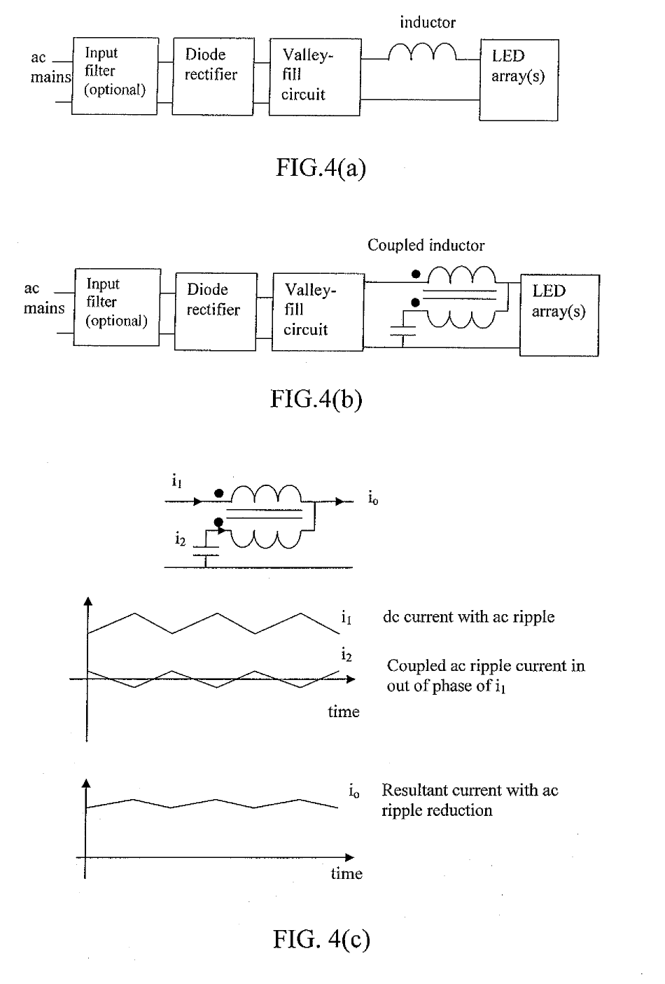

In embodiments of the invention an inductor (FIG. 4(a)) or a coupled inductor with ripple cancellation (FIG. 4(b)) may be used to limit the output current ripple and hence the power variation for the LED load.

FIG. 4(a) and FIG. 4(b) show schematic diagrams of passive circuits according to embodiments of the invention that can provide high reliability, long lifetime and low cost. Each system consists of a diode rectifier, a valley-fill circuit for improving the input power factor, an inductor for turning the voltage source into a current source with reduced current ripple (FIG. 4(a)) and the LED load. An alternative embodiment as shown in FIG. 4(b) is to replace the inductor in FIG. 4(a) with a coupled inductor and a capacitor so that these components form a coupled inductor with current ripple cancellation function. It will be shown that such current ripple cancellation which is commonly used in high-frequency (0.20 kHz) switching power supplies can also be effective in low-frequency operation. The LED load could be an LED array or multiple arrays in modular forms. Various valley-fill circuits or their improved versions can be used to improve the input power factor. In embodiments of this invention, non-electrolytic capacitors are used in the valley-fill circuit and current-ripple cancellation circuit. Either a standard valley-fill circuit, a valley-fill circuit with voltage doubler or any variant of the valley-fill circuit can be used in this invention.

Considering firstly FIG. 4(a), let the output voltage of the valley-fill circuit be Vₒᵤₜ and the overall voltage of the LED module (with LED devices connected in series) be V_{LED}. The inductance of the inductor can be designed to limit the current through the LED module because the current ripple ΔI_{LED} can be expressed as:

$$Δ {I}_{L E D} = \frac{( {V}_{out} - {V}_{L E D} ) Δ t}{L}$$

where Δt is the time period during the current change.

From the above equation, it can be seen that the size of the inductor L can be used to reduce the current ripple, which in turn can limit the change of total LED power because

ΔP_{LED}=V_{LED}ΔI_{LED}

An alternative shown in FIG. 4(b) is to use a coupled inductor with current ripple cancellation as described in the following [Hamill, D. C.; Krein, P. T.; “A ‘zero’ ripple technique applicable to any DC converter,” 30th Annual IEEE Power Electronics Specialists Conference, 1999, PESC 99. Volume 2, 27 Jun.-1 Jul. 1999, page 1165-1171; Schutten, M. J.; Steigerwald, R. L.; Sabate, J. A.; “Ripple current cancellation circuit,” Eighteenth Annual IEEE Applied Power Electronics Conference and Exposition, 2003. APEC '03. Volume 1, 9-13 Feb. 2003, pages 464-470; Cheng, D. K. W.; Liu, X. C.; Lee, Y. S.; “A new improved boost converter with ripple free input current using coupled inductors,” Seventh International Conference on Power Electronics and Variable Speed Drives, 1998. (Conf Publ. No. 456) 21-23 Sep. 1998, pages 592-599], incorporated herein by reference. The primary winding of the coupled inductor is used as the dc inductor just as in the embodiment of FIG. 4(a). The secondary winding is coupled to the primary winding and provides the ac current to reduce the ripple in the load. When the primary current in the first inductor is increasing into the dotted terminal of the primary winding (i.e., changing positively), ac flux caused by the increasing primary current is coupled to the secondary ac winding. The transformer action causes a current to flow out of the dotted terminal of the secondary winding into a capacitor in order to cancel the ac flux. Thus, the overall current ripple in the output of the coupled inductor (including both primary and secondary windings) and the load is reduced. Similarly, when the primary current flowing into the dotted terminal of the primary winding is decreasing (i.e., changing negatively), the ac flux coupled to the secondary winding will cause a current to flow into the dotted terminal of the secondary winding and hence reduce the overall current ripple of the couple inductor. The effect of the coupled inductor on reducing the current ripple is illustrated in FIG. 4(c).

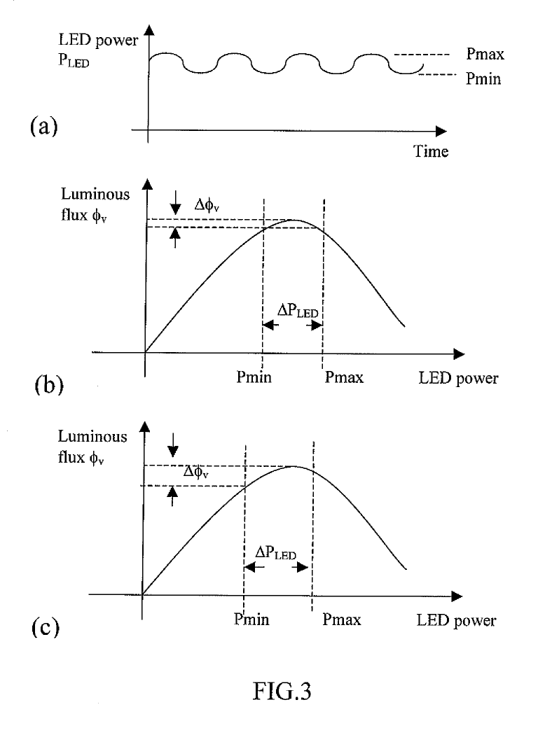

In embodiments of the present invention there will be fluctuation of the LED load power, but it is possible to obtain luminous output from the LED system with minimum luminous flux fluctuation even though the LED load power will fluctuate. This can be seen by considering the relationship between the luminous flux φᵥ and LED power P_{d} as shown in FIGS. 3(a)-(c). Let us label the maximum power and minimum power of the LED load as Pmax and Pmin, respectively in FIG. 3(a). It has been shown that the relationship of the luminous flux and the power of a LED system follows an asymmetric parabolic curve as shown in FIG. 3(b) [Hui S. Y. R. and Qin Y. X., “General photo-electro-thermal theory for light-emitting diodes (LED) systems,” IEEE Applied Power Electronics Conference, February 2009, Washington D.C., USA, paper 16.2; U.S. Ser. No. 12/370,101 the contents of which are incorporated herein by reference]. If the LED system is designed such that Pmax and Pmin enclose the peak region of the luminous flux—LED power curve where the slope of the curve is minimum as shown in FIG. 3(b), a significant variation of LED power (ΔP_{LED}) will only lead to a relatively small variation in the luminous flux (Δφᵥ). An alternative is to design the LED thermal design so that Pₘₐₓ and Pₘᵢₙ fall within a region of the luminous flux—LED power curve where the slope of the curve is relatively small (i.e., near the peak value) as shown in FIG. 3(c).

In this way, the control circuit can use non-electrolytic capacitors without causing a large variation in the light output of the LED system. This concept can be implemented in existing electronic ballasts by replacing the electrolytic capacitors with other capacitors of lower values and re-designing the LED system so that the LED power variation falls within the peak luminous flux region in the luminous flux—LED power curve.

Another aspect of the present invention involves the use of novel passive power circuits that can achieve the advantages proposed above without using active electronic switches. Without using active electronics switches, the proposed circuits do not need an electronic control circuit for the switches and can be much more reliable, long-lasting and have lower costs than their active electronic counterparts.

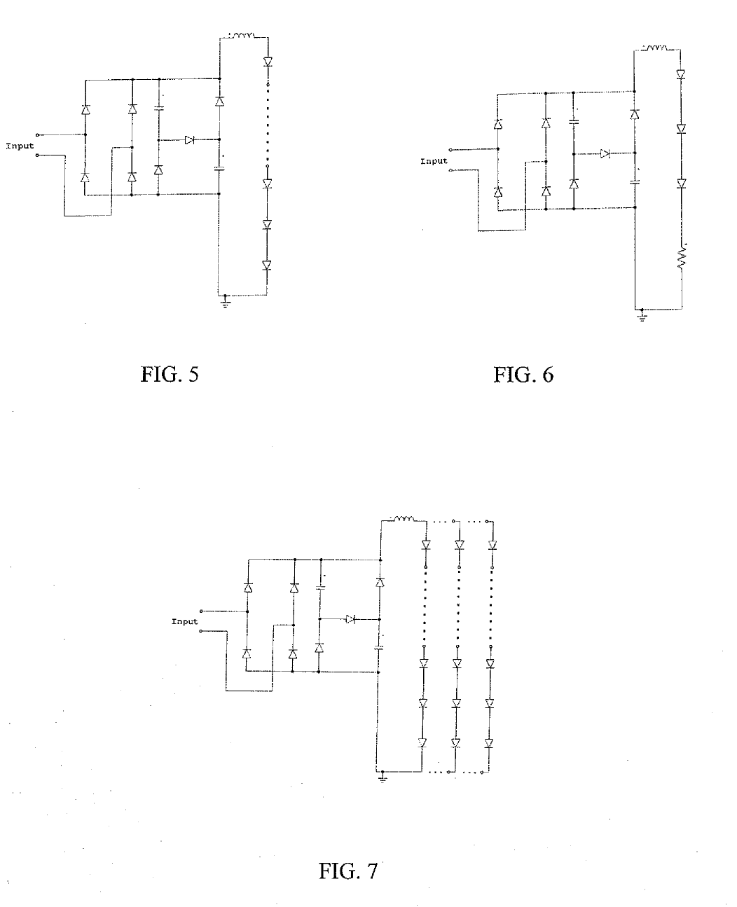

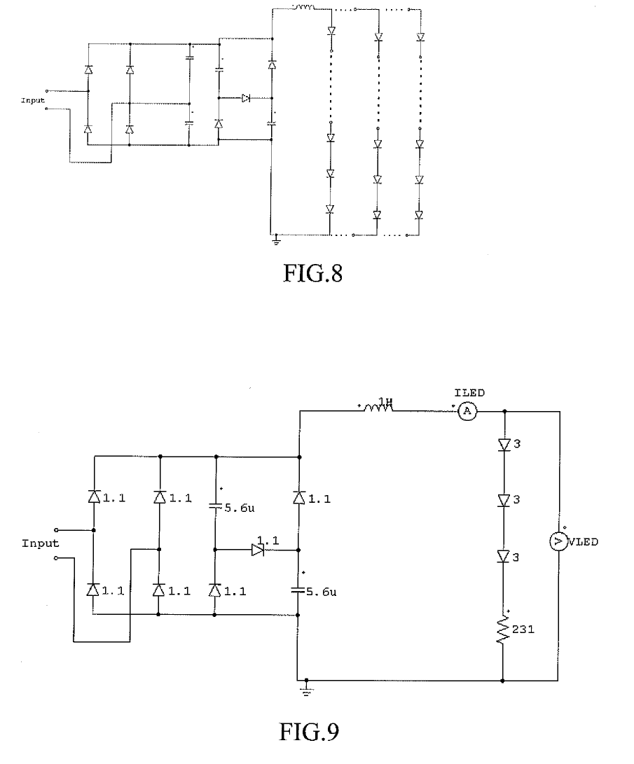

FIG. 5 shows a circuit diagram based on a standard valley-fill circuit. In the actual simulation as shown in FIG. 6, a small number of LED devices are represented by individual diodes and a large number of the LED devices are represented by an equivalent resistor that has the same voltage drop and consumes the same power of that group of LED devices when the rated current flow through these series connected devices. A valley-fill circuit with a voltage doubler as shown in FIG. 7 can also be used if desired. If multiple LED modules are used as shown in FIG. 8, current-balancing devices can be added to ensure that each LED array module shares the same current.

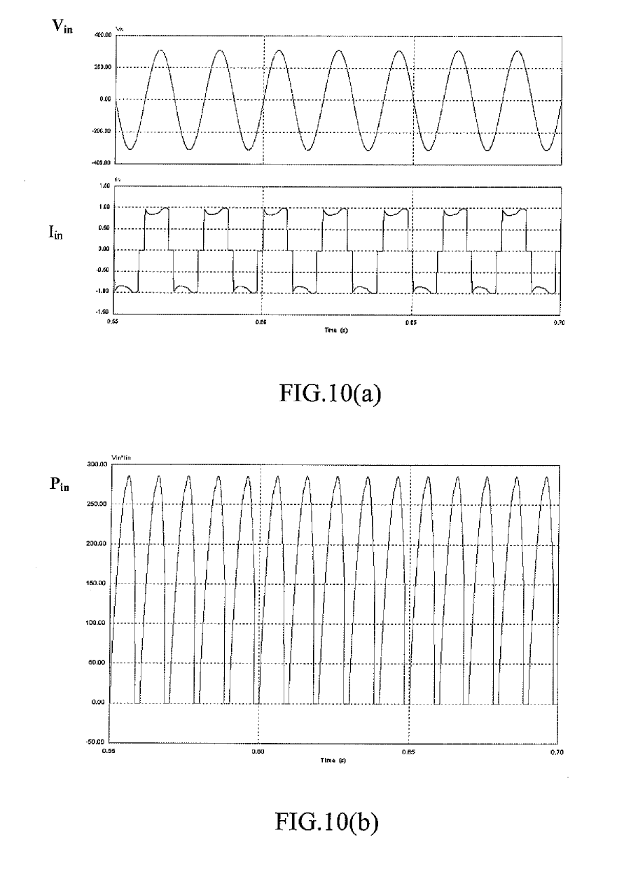

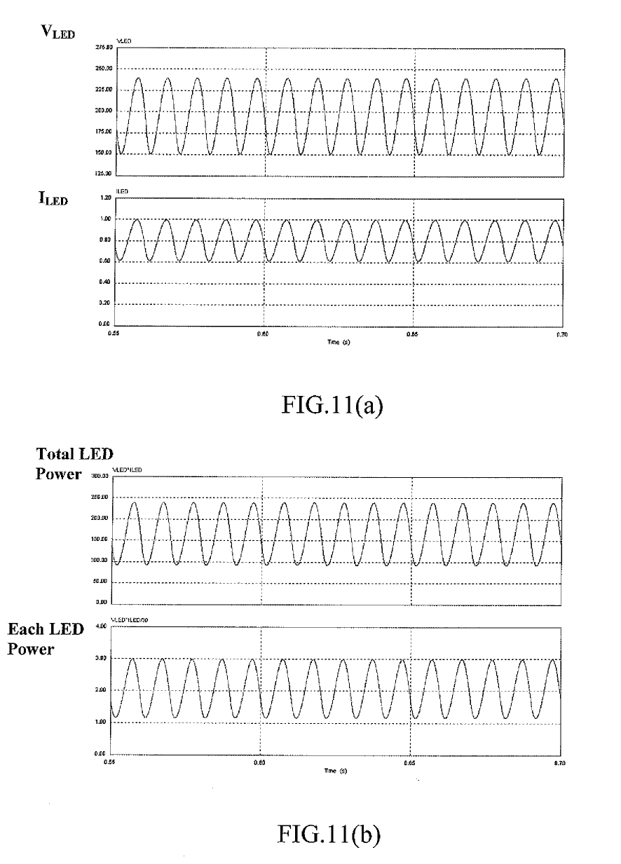

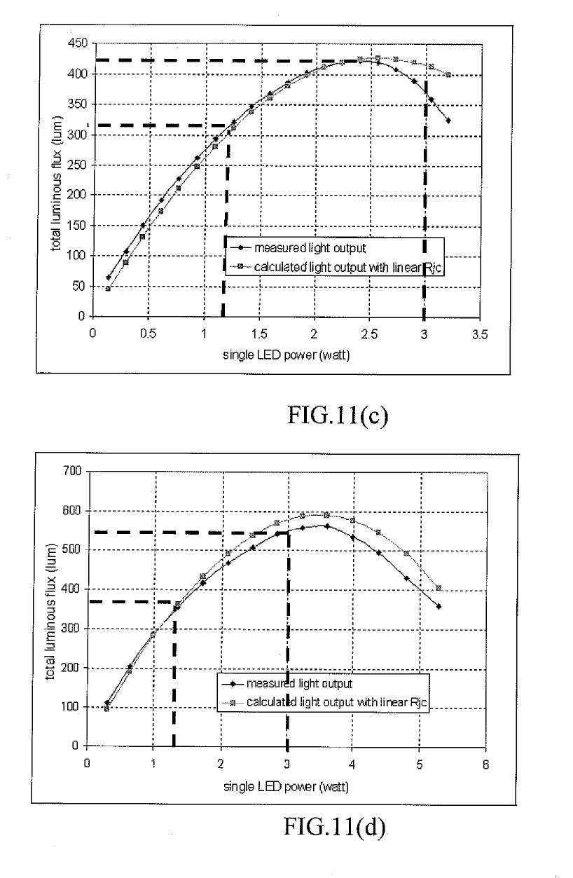

In order to illustrate this aspect of the present invention, the passive circuit of FIG. 9 is used to drive a series of 3 W LEDs. In the simulation, three diodes are used while the rest of the diodes are represented as an equivalent resistor as explained previously. FIG. 10(a) shows the simulated input voltage and current of the entire system. It can be seen that the input current waveform is not a sharp pulse (as would be expected from a diode bridge with an output capacitor) and the power factor has therefore been improved. FIG. 10(b) shows the input power of the system. FIG. 11(a) shows the simulated voltage and current of the LED module. The inductor is designed so that the LED rated current of 1 A (for the 3 W LED devices) is not exceeded in this example. Despite the pulsating input power, the reduction of the voltage fluctuation due to the use of the valley-fill circuit and the filtering effect of the inductor have smoothed the load current considerably. FIG. 11(b) shows the total LED power and individual LED power. It can be seen that the power variation is within 1.2 W to 3 W (i.e., 60%) in this example. This simulation study confirms that a passive circuit without electrolytic capacitors and active switches can be designed to provide a current source with controlled current ripple for a LED system with input power factor correction.

This per-unit result of LED power in FIG. 11 can be interpreted with typical LED systems with different thermal designs. For example, it has been shown that the luminous flux—LED power curves depend on the thermal resistance of the heatsinks. FIG. 11(c) and FIG. 11(d) show typical curves for LED systems using two different heatsinks for eight 3 W LEDs. The heatsink used for FIG. 11(c) is smaller than that for FIG. 11(d). For the example in FIG. 11(c), a 60% variation from 1.2 W to 3 W for each device will lead to about 24% of light variation. For the example of FIG. 11(d), a 60% variation of LED power leads to 30% of light variation.

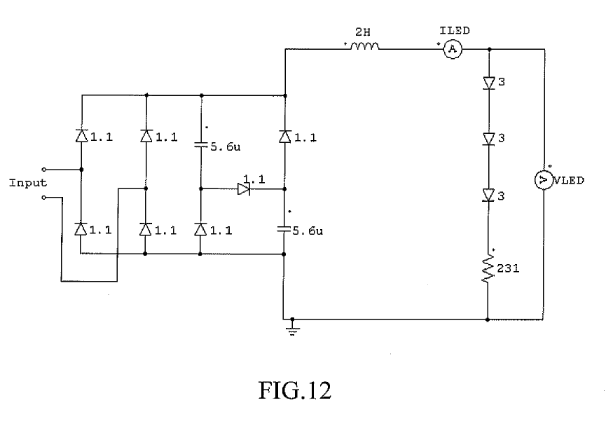

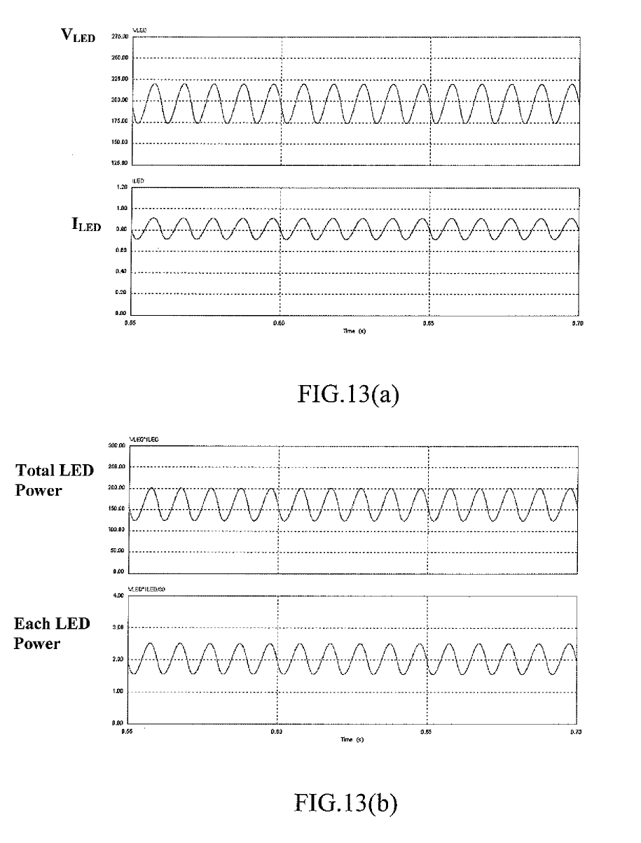

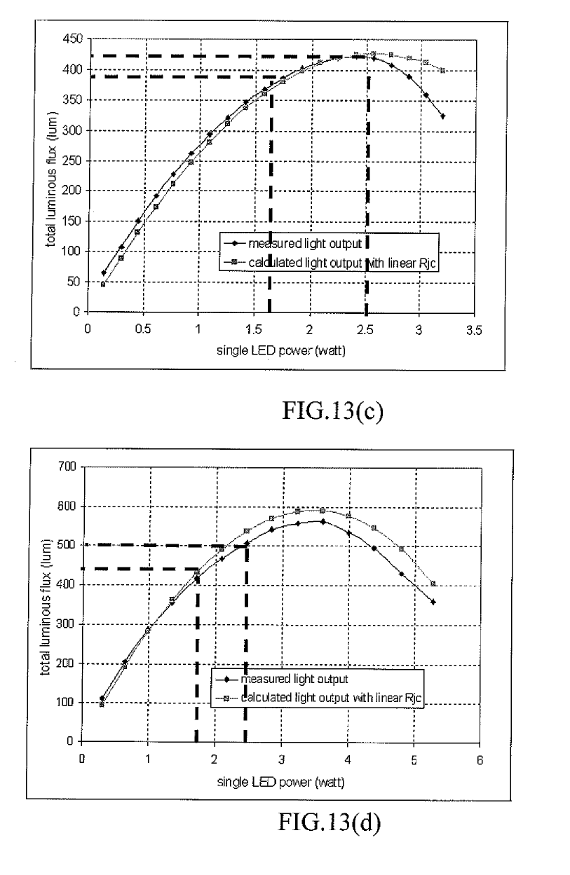

However, it is important to note that the choice of inductance of the inductor can control the current ripple and therefore the LED power variation. If the inductance L is increased from 1 H to 2 H (FIG. 12), the simulated LED voltage and current waveforms are plotted in FIG. 13(a). The corresponding total LED power and individual LED power are included in FIG. 13(b).

It can be seen that, with L increased to 2 H, the power variation (from 1.6 W to 2.5 W) is 36%. If the same power variation is applied to the two examples in reference Hui, et al [Hui S. Y. R. and Qin Y. X., “General photo-electro-thermal theory for light-emitting diodes (LED) systems,” IEEE Applied Power Electronics Conference, February 2009, Washington D.C., USA, paper 16.2], incorporated herein by reference, FIG. 13(c) and FIG. 13(d) show that the variation in the luminous flux is approximately 7% and 12%, respectively. It is envisaged that human eyes are not sensitive to such small changes of luminous flux variation.

It can be seen that a large inductance can reduce the current ripple and LED power variation. The choice of L depends also on the core loss and copper loss in the inductor. The overall design therefore relies on the thermal design as explained in Hui et al and the choice of L so that the operating range can be restricted to the region of the luminous flux—LED power curve where the slope of the curve is small.

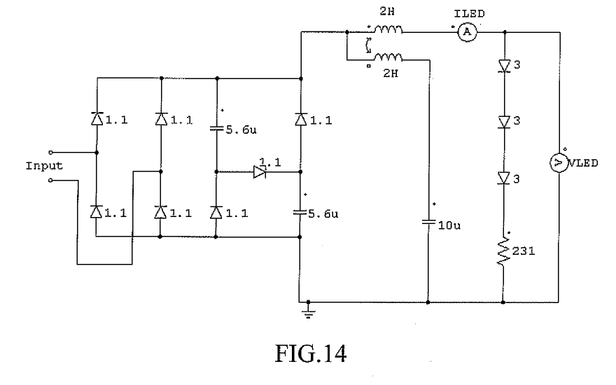

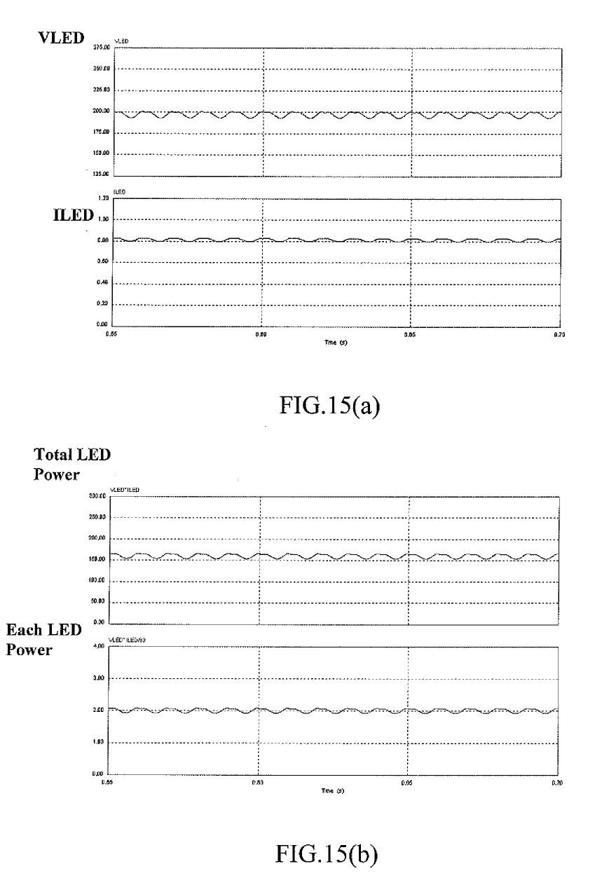

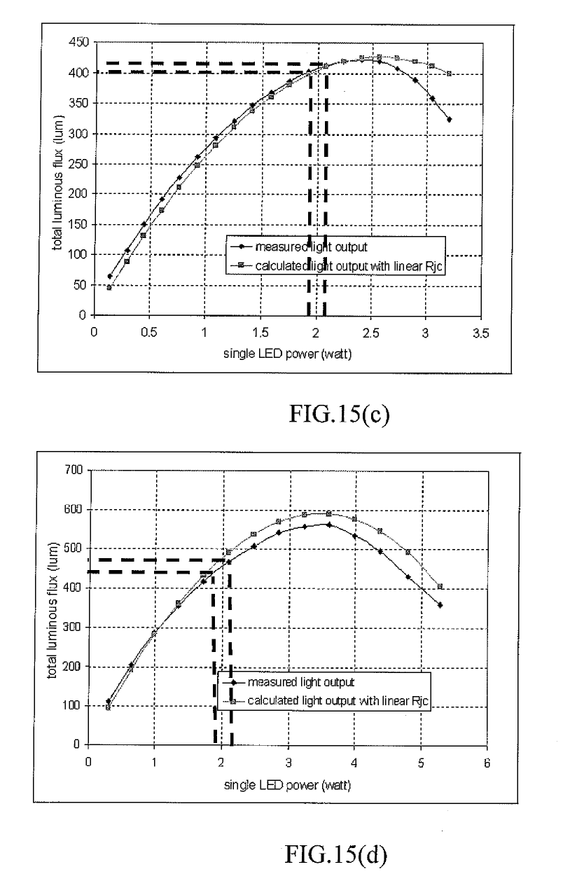

An effective method to further reduce the current ripple and thus LED power variation and light variation is to replace the inductor in FIG. 9 and FIG. 12 with a current-ripple cancellation means in the form of a coupled inductor and a capacitor as shown in FIG. 14. FIG. 15(a) and FIG. 15(b) show the electrical measurements of the system. It can be seen the variations in the LED current ripple and power have been greatly reduced. The power variation is only within 0.2 W (from 1.9 W to 2.1 W). This 9% power variation will lead to less than 4% of light variation in the two examples as shown in FIG. 15(c) and FIG. 15(d).

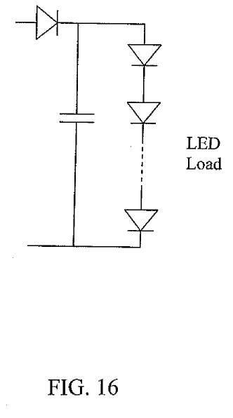

It should also be noted that it may be desirable to provide a diode-capacitor clamp that can be added to each LED string to provide a current path for the inductor current in case some of the LED devices fail. An example of such a possibility is shown in FIG. 16.

From the above it will be seen that in preferred embodiments of the present invention there is proposed the use of a passive power correction circuit such as the valley-fill circuit to reduce the voltage ripple feeding the inductor (or coupled inductor with a capacitor in the form of current ripple cancellation circuit) and the LED modules in order to (i) reduce the current ripple and thus the power variation in the LEDs and (ii) to improve the input power factor. The allowance of some current and power variation in the LEDs within the region of the luminous flux—LED power curve where the slope of the curve is small will lead to only a small variation of the luminous flux from the LED system. The use of the inductance of the inductor or coupled inductor in the form of a current ripple cancellation circuit to further limit the power variation of the LED system.

By using a suitable thermal design the power variation range of the LED load can be designed to fall within the region of the luminous flux—LED power curve where the slope is small and the luminous flux is maximum or near maximum.

As a consequence of the requirement of only small capacitance in the proposed system, electrolytic capacitors can be eliminated from this design. Since the entire circuit consists of passive and robust components (such as power diodes, non-electrolytic capacitors and inductors) only and does not need extra control electronics, it features low-cost, high robustness and reliability.

One possible issue, however, is that the abovedescribed circuits assume a reasonably constant input voltage which may not necessarily be true. In countries where the AC mains supply is unreliable or in any other situation where there may be AC mains voltage fluctuation for whatever reason, there could be a significant variation in the LED power for a given nominal AC input voltage. In preferred embodiments of the invention therefore it may be preferable to provide a means for controlling the power sensitivity of the load against AC voltage fluctuation.

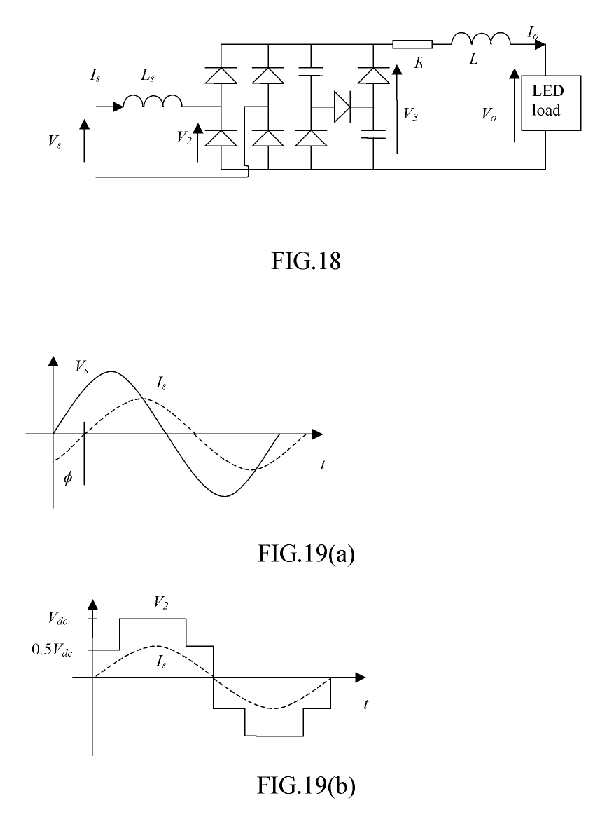

FIG. 18 shows one example of a circuit provided with means for controlling the power sensitivity of the load against AC voltage fluctuation. In this example a passive ballast for an LED system is shown provided with a diode rectifier, a valley-fill circuit for reducing the voltage ripple of the rectified DC power, and a filter inductor L for generating a current source provided to the LED load. It will be understood that as described above the inductor L could instead by replaced by a current ripple reduction circuit comprising a coupled inductor with a capacitor. In this circuit an input inductor Lₛ is provided in series between the AC supply Vₛ and the diode rectifier which as will be explained below provides the necessary power sensitivity control.

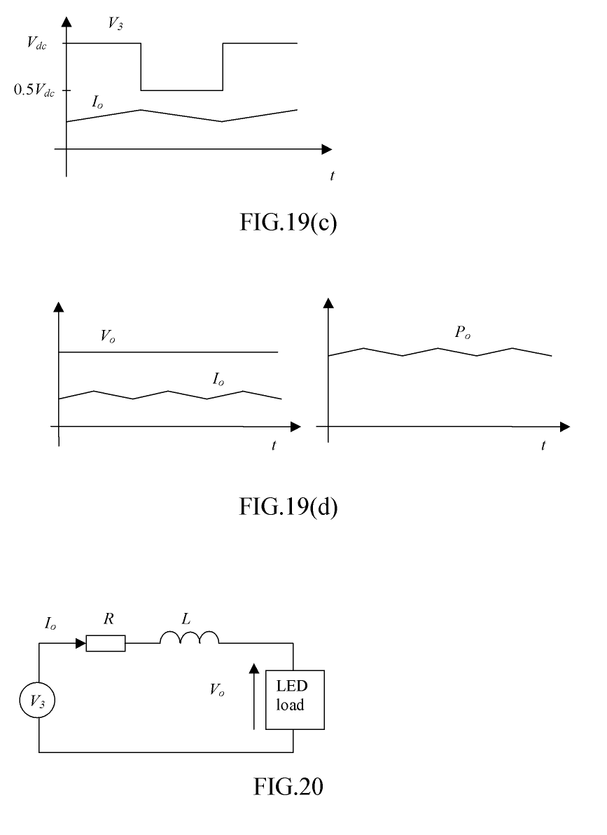

FIGS. 19(a)-(d) show the idealized waveforms of the proposed AC-DC current source circuit for LED loads. In particular: FIG. 19(a) shows idealized waveforms of input AC mains voltage and current (with a phase shift (φ) between Vₛ and Iₛ); FIG. 19(b) shows idealized waveforms of input voltage V₂ and current Iₛ of the diode rectifier (with V₂ and Iₛ in phase); FIG. 19(c) shows idealized waveforms of output voltage V₃ and current Iₒ of the valley-fill circuit (with V₃ a rectified version of V₂); and FIG. 19(d) shows idealized waveforms of voltage across LED load (Vₒ), output load current (Iₒ) and the output load power (Pₒ).

An analysis of this circuit can start from the load side by considering the equivalent circuit as shown in FIG. 20 where the inductor winding resistance is shown as R and the total LED load voltage drop V₀ is considered to be constant.

From FIG. 20, the average output current Īₒ can be expressed as:

$${\overline{I}}_{o} = \frac{{\overline{V}}_{3} - {V}_{o}}{R} \qquad ( 1 )$$

where V₃ is the average voltage of V₃.
From the waveform of V₃ in FIG. 19(c),

$$\begin{matrix}{\overline{V}}_{3} = \frac{3}{4} {V}_{dc} & ( 2 ) \\ {V}_{dc} = \frac{4}{3} {\overline{V}}_{3} = \frac{4}{3} ( {V}_{o} + {\overline{I}}_{o} R ) & ( 3 )\end{matrix}$$

It should be noted that the total voltage drop of the LED load is approximated as a constant Vₒ. Therefore, V_{dc} does not change significantly if Īₒ does not change significantly. In general, Vₒ is much bigger than ĪₒR. Thus V_{dc} is close to 1.33Vₒ. The next issue is to find out a way to reduce the change of Iₒ due to fluctuation in the input mains voltage.

By the law of conservation of energy, input power is equal to the power entering the diode bridge, assuming that the input inductor Lₛ has negligible resistance. Also and note that V₂₁ and I_{S} are in phase as shown in FIG. 19(b).

V_{S}I_{S} cos φ=V₂₁I_{S} (4)

where V₂₁ is the fundamental component of V₂.

Similarly, the input power is also equal to the output power of the valley-fill circuit, assuming that the power loss in the diode rectifier and valley-fill circuit is negligible.

$${V}_{S} {I}_{S} cos φ = {\overline{V}}_{3} {\overline{I}}_{o} = \frac{3}{4} {V}_{dc} {\overline{I}}_{o} = {\overline{I}}_{o}^{2} R + {\overline{I}}_{o} {V}_{o} \qquad ( 5 )$$

If the inductor winding resistance is negligible, R=0, leading to

$${V}_{o} = \frac{3}{4} {V}_{dc} \qquad ( 6 )$$

Using Fourier analysis on the waveform of V₂, the fundamental component V₂₁ of V₂ can be determined as:

$${V}_{21} = \frac{( 2 + \sqrt{2} ) {V}_{dc}}{π} sin ( ω t - φ ) = 1.086 \cdot {V}_{dc} sin ( ω t - φ ) \qquad ( 7 a )$$

The root-mean-square value of V₂₁ is therefore

$${V}_{21 \_rms} = \frac{1.086}{\sqrt{2}} \cdot {V}_{dc} = 0.77 \cdot {V}_{dc} \qquad ( 7 b )$$

Dividing (4) by (5) to relate V₂₁ and V_{dc}, and using (7b), one can relate Iₛ and Īₒ.

0.77V_{dc}I_{S}=0.75V_{dc}Īₒ [symbol] I_{S}=0.974Īₒ (8)

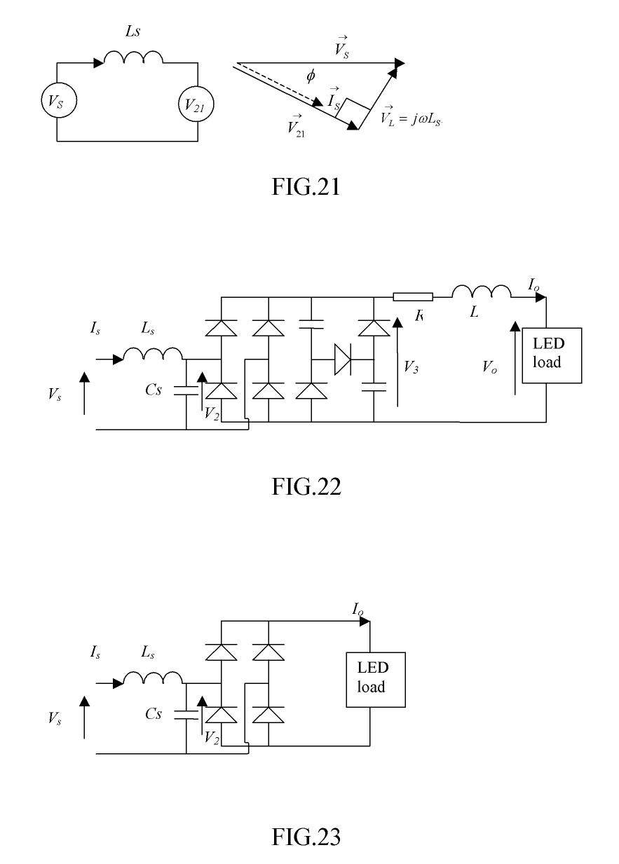

Now consider the equivalent circuit and the vectorial relationship between Vₛ and V₂₁ as shown in FIG. 21.

From FIG. 21

V_{S}²=V₂₁²+(ωL_{S}Iₛ)² (9)

and

$${{I}^{->}}_{s} = \frac{{{V}^{->}}_{s} - {{V}^{->}}_{21}}{jω {L}_{s}} \qquad ( 10 )$$

From (6), it can be seen that V₂₁ depends on V_{dc}, which is approximately close to 1.33Vₒ (approximated as a constant value). With the help of (8),

$${\overline{I}}_{o} = \frac{{V}_{S} - {V}_{21}}{0.974 \cdot ω {L}_{S}} \qquad ( 11 )$$

Differentiating (11) will lead to

$$Δ {\overline{I}}_{o} = \frac{Δ {V}_{S}}{0.974 \cdot ω {L}_{S}} \qquad ( 12 )$$

Equation (12) is the important equation which shows that the input inductance Ls can be used to reduce the change of average output load current ΔĪₒ for a given change in the input AC mains voltage ΔV_{S}. Take an example. For an AC mains of 50 Hz, the angular frequency ω is equal to 100 π, that is 314.16. For an Ls of 1 H, the effect of input voltage fluctuation on the output average current will be reduced by 314.16 times as shown in (12). For an Ls of 2 H, the reduction will be 618 times. For this sensitivity control to be effective, the size of the input inductor Ls has to be reasonably large (typically near to or in the order of Henry).

In order to provide a conducting path for the inductor current in Ls in case there is any problem in other part of the circuit which may create a discontinuation of current, a capacitor Cs can be placed to the second end of the input inductor as shown in FIG. 22. This LsCs arrangement will also play the additional role of input filter. But the main purpose of using a “large” Ls here is to reduce the sensitivity of the output load current (and thus output load power) of the proposed circuit to input voltage fluctuation.

In order to relate Īₒ with Vs, we start with modifying (9) with the help of (7b) and (8) gives:

$${V}_{S}^{2} = {( 0.77 {V}_{dc} )}^{2} + {[ ω {L}_{S} ( 0.974 {\overline{I}}_{o} ) ]}^{2} \qquad ( 13 )$$

Using (6), (13) becomes:

$${V}_{S}^{2} = {[ ( 0.77 ) ( \frac{4}{3} ) {V}_{o} ]}^{2} + {[ ω {L}_{S} ( 0.974 {\overline{I}}_{o} ) ]}^{2} \qquad ( 14 )$$

Solving (14) gives:

$${\overline{I}}_{o} = \frac{\sqrt{{V}_{s}^{2} - {( 1.072 \cdot {V}_{o} )}^{2}}}{0.974 \cdot ω {L}_{s}} \qquad ( 15 )$$

Note that Vₒ can be determined from the number of LED devices in the LED strings. If Ls is chosen, then (15) provides the relationship between the average output current and the input ac mains voltage.

The LED load power is therefore:

$${\overline{P}}_{o} = {V}_{o} \cdot \frac{\sqrt{{V}_{s}^{2} - {( 1.072 \cdot {V}_{o} )}^{2}}}{0.974 \cdot ω {L}_{s}}$$

From the above it can be seen that by providing an input inductor in series between the AC supply voltage and the diode rectifier the sensitivity of the LED power to fluctuation in the AC supply voltage can be reduced.

Indeed the provision of an input inductor in series between the AC supply voltage and the diode rectifier may have useful applications as a means for limiting variations in the power of the LED load in circuits that do not include voltage ripple reduction. FIG. 23 shows an example of such a circuit where the input inductor Lₛ is provided in series between the AC supply voltage Vₛ and a diode rectifier the output of which is provided directly to the load. As with the circuit of FIG. 22 a capacitor Cₛ may be provided in parallel between the input inductor and the diode rectifier to provide a conducting path in the event of any short-circuit or other problem in another part of the circuit, and also to provide a filtering function.

While several aspects of the present invention have been described and depicted herein, alternative aspects may be effected by those skilled in the art to accomplish the same objectives. Accordingly, it is intended by the appended claims to cover all such alternative aspects as fall within the true spirit and scope of the invention.

1. An LED lighting system comprising:
a rectification circuit for rectifying an AC input power and generating a rectified DC power;
a first circuit electrically coupled to the rectification circuit for reducing a voltage ripple of said rectified DC power;
a second circuit electrically coupled to the first circuit for generating a current source from the voltage ripple reduced rectified DC power; and
at least one LED electrically coupled to the second circuit and receiving said current source as an input.

2. The LED lighting system of claim 1, wherein said first circuit comprises a valley-fill circuit located between said rectification circuit and said second circuit.

3. The LED lighting system of claim 2, wherein said valley-fill circuit comprises a voltage-doubler.

4. The LED lighting system of claim 1, wherein said second circuit comprises an inductor.

5. The LED lighting system of claim 1, wherein said second circuit comprises a current ripple reduction circuit.

6. The LED lighting system of claim 5, wherein said current ripple reduction circuit comprises a coupled inductor with a capacitor.

7. The LED lighting system of claim 1, further comprising means for controlling a sensitivity of LED power to fluctuations in AC input power voltage.

8. The LED lighting system of claim 7, wherein said controlling means comprises an inductor situated in series between the AC input and the rectification circuit.

9. The LED lighting system of claim 8, further comprising a capacitor situated in parallel between said inductor and said rectification circuit.

10. The LED lighting system of claim 1, wherein power supplied to said at least one LED is permitted to vary, and wherein at least one operating and/or design parameter of said at least one LED is chosen such that a variation in luminous flux resulting from the varying power is not observable to the human eye.

11. An LED lighting system comprising:
an AC input power source;
a rectification circuit for rectifying an AC input power and generating a rectified DC power; and
an inductor situated in series between the AC input power source and the rectification circuit.

12. The LED lighting system of claim 11, further comprising a capacitor situated in parallel between said inductor and said rectification circuit.

13. A method of operating a LED lighting system comprising:
rectifying an AC input voltage to generate a rectified DC power;
reducing a voltage ripple of said rectified DC power;
generating a current source from said voltage ripple reduced rectified DC power; and
providing said current source as an input to at least one LED, wherein the power supplied to said at least one LED is permitted to vary, and wherein at least one operating and/or design parameter of said at least one LED is chosen such that a variation in luminous flux resulting from the varying power is not observable to the human eye.

14. The method of claim 13, wherein a thermal characteristic of the at least one said LED is chosen such that the variation in luminous flux resulting from the varying power is not observable to the human eye.

15. The method of claim 14, wherein said thermal characteristic comprises a design of a heatsink for the at least one LED.

16. The method of claim 14, wherein said thermal characteristic comprises the provision of forced cooling or natural cooling.

17. The method of claim 13, wherein the reducing comprises using a valley-fill circuit to reduce the voltage ripple of the rectified DC power.

18. The method of claim 17, wherein said valley-fill circuit comprises a voltage-doubler.

19. The method of claim 18, further comprising reducing a current ripple of said current source.

20. The method of claim 19, wherein reducing the current ripple is accomplished using a coupled inductor with a capacitor.

21. The method of claim 18, further comprising reducing a sensitivity of LED power to fluctuations in the AC input voltage.
